(19) United States
(12) Patent Application Publication
(10) Pub. No.: US 2007/0147263 A1
(43) Pub. Date: Jun. 28, 2007

(54) METHOD FOR TRANSMITTING REAL-TIME STREAMING DATA AND APPARATUS USING THE SAME

(76) Inventors: Jian-Zhi Liao, Taichung County (TW); Chia-Hsing Lee, Taipei City (TW); Yong-Sheng He, Taichung City (TW); Sin-Chang Huang, Taipei City (TW); Yi-Der Lin, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,103

(22) Filed: Jun. 23, 2006

(30) Foreign Application Priority Data
Dec. 28, 2005 (TW) 94146907

(51) Int. Cl. H04J 1/16; H04L 12/16; H04L 12/28; H04L 12/66

(52) U.S. Cl. 370/252; 370/260; 370/352; 370/389

(57) ABSTRACT

A method and an apparatus for transmitting real-time streaming data are provided. The apparatus has a first terminal, a second terminal, and a relay server. Real-time streaming transmission paths between the first terminal and the relay server as well as between the second terminal and the relay server are established, and the first and the second terminals can obtain information from each other. Whether the first and the second terminals are directly connectable or tested. When the first and the second terminals can be connected directly, the first terminal alters the real-time streaming transmission path directly to the second terminal without passing through the relay server. When the second terminal can be connected directly to the first terminal, the second terminal alters the real-time streaming data transmission path directly to the first terminal with passing through the relay server.

### CROSS-REFERENCE TO RELATED APPLICATION

This application claims the priority benefit of Taiwan application serial no. 94146907, filed on Dec. 28, 2005. All disclosure of the Taiwan application is incorporated herein by reference.

### BACKGROUND OF THE INVENTION

1. Field of Invention

The present invention relates to a transmission method for streaming service and an apparatus thereof. More particularly, the present invention relates to a method for streaming service transmission capable of shortening the transmission path, and an apparatus thereof.

2. Description of Related Art

In recent years, network multimedia has been developed quickly along with the rapid development of network technology. The streaming technology is developed to transmit real-time multimedia data smoothly and continuously. For example, a telephone service through Internet called Voice over Internet Protocol (VoIP) has been developed along with the widespread application of P2P streaming transmission. VoIP is an audio service, in which audio signals are compressed into digital data packets and the packets are transmitted over IP network; that is, a telecommunication application service transmitting audio through the Internet.

In addition, the Internet is an open network, and enterprises or personals also build their own private network, i.e., Intranets. On awareness of network security, Network Address Translation (NAT)/Firewall are usually set up between an Intranet and the Internet. NAT service has 3 main purposes: 1) providing the function of Firewall so as to hide internal IP addresses; 2) allowing the enterprise to use more IP addresses; 3) allowing the enterprise to integrate multiple ISDN connection services into a single Internet connection. In other words, NAT can solve the problem of inadequate IP addresses and allows the internal network of an enterprise to be protected as well. However, the setup of NAT brings difficulty to peer-to-peer transmission, for example, the VoIP service described above, and this problem becomes more serious in Intranet with multiple NAT structures.

Thus, the resolution of VoIP service through NAT has become one of the essential conditions for this kind of services. However, there is no existing solution regarding special but common internal communication of Intranet, and obviously, waste of network resources or even decrease in streaming data transmission quality will be caused if existing method of working through NAT is used for internal communication on an Intranet.

FIG. 1 is a diagram of a conventional real-time streaming data transmission path through a relay server. As illustrated in FIG. 1, when the VoIP service is to be performed behind the same NAT1, the terminal UA1 has to transmit information to the relay server RS, then the relay server RS serves as the terminal UA1 to transmit the information to the terminal UA2 (paths A, B). Similarly, when the terminal UA2 is going to respond to terminal UA1, information is also transmitted to the relay server RS first, then the relay server RS transmits the information to the terminal UA1. Similarly, if the terminal UA1 wants to communicate with the terminal UA5, the communication is through the relay server RS and the transmission paths are A and C. Under this structure, the terminals don't know the actual locations of one another regardless caller or receiver. Thus, even the terminals UA1 and UA2 are located behind the same NAT and belongs to the same domain, the communication has to be carried out by transmitting the information to the external relay server through multiple NATs. Obviously, this transmission method wastes network resources to those end-users behind the same NAT.

Presently, there are several methods for processing transmission behind the NAT servers. U.S. Patent Application No. US20040252683 discloses a method which allows two VoIP users located behind the NAT to communicate. Before the communication is established, which user terminal is located behind the NAT, or both are located behind the NAT, or even the two users are located behind the same NAT has to be determined first. Special messages are exchanged and the communication is further established according to different situations after the determination. This patent can process communication between users located behind the NAT. However, this patent cannot determine whether the users are located behind the same NAT.

In addition, U.S. Patent Application No. US20050100047 discloses a process saving media data transmission, especially to users behind the NAT. The method of this patent is to alter the data structure in SIP so as to send media data to a proxy server first, and then relay the media data to the other terminal by the proxy server. However, if the NAT of the user terminal is a symmetric translation, then the patent can not be applied. Even this patent is to establish a VoIP conversation channel for users behind the NAT, network resources cannot be saved or the quality of the conversation cannot be improved.

In summary, the real-time streaming packet transmission has to go through a relay server in present technologies. Even all the users are located behind the same NAT, the real-time streaming packet transmission has to be carried out through an external relay server. This method results in waste of network resources and decrease in the communication quality. Thus, it is very important to find out the shortest routing so as to save network resources when processing some particular routing problems.

### SUMMARY OF THE INVENTION

Accordingly, the present invention is to provide a method for transmitting real-time streaming data and the apparatus thereof, which can reduce unnecessary streaming data packet routing and waste of network resources, and can find out the shortest data transmission path regarding common internal communication on Intranet. In other words, when the two end-users performing streaming data transmission are located behind the same NAT, the streaming data packets can be transmitted without going through relay server.

In addition, the present invention is to provide a method for transmitting real-time streaming data and the apparatus thereof, which allows two end-users to transmit streaming data packets to one another directly so as to reduce the network bandwidth and the burden of the server caused by routing the packets through NAT, and to transmit the packets to the destination terminal quickly.

In order to achieve at least the foregoing objects, the present invention provides a real-time streaming packet transmission method, which adapted for a configuration having a first terminal, a second terminal and a relay server. The real-time streaming packet transmission method includes the following steps: (a) establishing a signaling exchange path between the first terminal and the relay server and a signaling exchange path between the second terminal and the relay server, and the first and the second terminals being able to obtain information from each other, wherein after the first and the second terminal obtain the information from the relay server and the opposite terminal, a streaming transmission channel is established first through the relay server; (b) determining whether a connection can be directly established from the first terminal to the second terminal or from the second terminal to the first terminal; and (c) when the first terminal can be directly connected to the second terminal, the first terminal changing the streaming transmission path to be directly connected to the second terminal without going through the relay server, and when the second terminal can be directly connected to the first terminal, the second terminal changing the streaming data transmission path to be directly connected to the first terminal without going through the relay server. If the streaming transmission channel between the first and the second terminal is not established during step (a), it's not necessary to acknowledge the relay server to change the streaming transmission path.

In the foregoing method, the step (a) further includes: the first terminal acknowledges the relay server of that a real-time streaming data transmission with the second terminal is to be established; the relay server attaches information of both the first terminal and the relay server to a signaling packet, and transmitting the signaling packet having the information of the first terminal and the relay server to the second terminal; when the second terminal has received the signaling packet from the first terminal, the second terminal responding to the relay server and attaches the information of the second terminal to the signaling packet, and then transmits the signaling packet to the relay server; the relay server attaches the information of both the second terminal and the relay server to the signaling packet sent by the second terminal and transmitting the signaling packet having the information of the relay server and the second terminal to the first terminal; if there is still no real-time streaming transmission path through the relay server existing between the first terminal and the second terminal, the first terminal can choose to establish a real-time streaming transmission path with the relay server first, or can also choose to establish the transmission path after performing step (b); similarly, the second terminal can choose to establish the real-time streaming transmission path with the relay server first, or can also establish the transmission path after performing step (b).

In the foregoing real-time streaming packet transmission method, step (b) further includes: the first terminal acknowledges the second terminal of the domain information of the first terminal; the second terminal queries the domain information of the first terminal; and when the domain information acknowledged by the first terminal is consistent with the domain information queried by the second terminal, the second terminal determines that the first terminal can be connected directly.

In the foregoing real-time streaming packet transmission method, step (b) further includes: the first terminal sends a special packet to the second terminal according to the information of the second terminal obtained in step (a); if the second terminal receives the special packet and responds to the first terminal, the first terminal determines that the second terminal is directly connectable.

In the foregoing real-time streaming packet transmission method, step (c) further includes: when the first terminal determines that the second terminal is directly connectable and a real-time steaming data transmission path through the relay server is existing between the first terminal and the second terminal, the first terminal sends an acknowledge signal to the relay server and request the relay server to release the real-time steaming data transmission path; after the first terminal receives the response from the relay server, the real-time steaming transmission path is changed to directly transmit the real-time streaming packet to the second terminal without going through the relay server; if there is no real-time steaming data transmission path existing between the first terminal and the second terminal yet, the first terminal establish direct streaming transmission path to the second terminal without acknowledging the relay server.

In the foregoing real-time streaming packet transmission method, when the first terminal determines that the second terminal can not be connected directly, the first terminal maintains the real-time steaming transmission path to the second terminal through the relay server.

In the foregoing real-time streaming packet transmission method, the information of the first terminal, the second terminal, and the relay server can be Internet addresses and port numbers.

In addition, the present invention further provides a real-time streaming packet transmission apparatus, which includes at least a relay server, a first terminal, and a second terminal. The relay server is set up on the Internet and is used for relaying real-time streaming packet. The first terminal is connected to the relay server through the Internet, in which when the first terminal sends a request signal to the relay server for establishing real-time streaming packet transmission, the information of the first terminal is attached to a signaling packet to be sent to the relay server. The second terminal is connected to the relay server through the Internet, in which the relay server attaches the information of the relay server to the signaling packet including the information of the first terminal, and sends the signaling packet including the information of the first terminal and the relay server to the second terminal, and the second terminal also sends its own information to the first terminal through the relay server. The first and the second terminal respectively test whether the second and the first terminals are directly connectable according to the received information of each other. When the first terminal is directly connectable to the second terminal, the first terminal changes the streaming transmission path to directly connect to the second terminal without going through the relay server, and when the second terminal is directly connectable to the first terminal, the second terminal changes the streaming transmission path to directly connect to the first terminal without going through the relay server.

In the foregoing real-time streaming packet transmission apparatus, DNS query can be used for testing whether the second and the first terminal are directly connectable or not. The first terminal acknowledges the second terminal of the domain information of the first terminal, and the second terminal queries the domain information of the first terminal. When the domain information acknowledged by the first terminal is consistent with the domain information queried by the second terminal, the first terminal determines that the second terminal is directly connectable.

In the foregoing real-time streaming packet transmission apparatus, a special request can be used for testing whether the second and the first terminals are directly connectable or not. The first terminal sends a special packet to the second terminal according to the obtained information of the second terminal. If the second terminal receives the special packet and responds to the first terminal, the first terminal determines that the second terminal is directly connectable.

In the foregoing real-time streaming packet transmission apparatus, when the first terminal determines that the second terminal is directly connectable, the first terminal sends an acknowledge signal to the relay server and requests the relay server to release the real-time steaming transmission path. After the first terminal receives the response of the relay server, the first terminal changes the real-time steaming data transmission path to directly transmit the real-time streaming packet to the second terminal without going through the relay server.

In the foregoing real-time streaming packet transmission apparatus, when the first terminal determines that the second terminal can not be connected directly, the first terminal maintains the real-time steaming transmission path to the second terminal through the relay server.

In the foregoing real-time streaming packet transmission apparatus, when there is no real-time steaming transmission path existing between the first terminal and the second terminal yet, and the second terminal is determined being not directly connectable in step (b), the first terminal has to establish a real-time steaming transmission path with the relay server for transmitting real-time streaming data.

In the foregoing real-time streaming packet transmission apparatus, the information of the first terminal, the second terminal, and the relay server can be Internet addresses and port numbers.

In summary, according to the present invention, after a real-time streaming transmission path is established between two end-users, the two end-users both transmit the information of itself and the relay server to one another. Thus, the two end-users can test whether the other terminal is directly connectable or not by using any method. When the other terminal is directly connectable, the transmission path is changed so that the transmission can be performed without going through the relay server, and when the other terminal is not directly connectable, the original transmission path through the relay server is maintained. Accordingly, the streaming packet transmission path can be shortened and the network resources can be saved. In another situation, after the two end-users have obtained the information of the opposite terminal and the relay server, the respective real-time streaming transmission path with the relay server is not established instantly, instead, it is determined to establish the real-time streaming transmission path after testing whether the other terminal is directly connectable or not. If the other terminal is directly connectable, the real-time streaming transmission path is established; if the other terminal cannot be connected directly, a real-time streaming transmission path through the relay server is established.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional real-time streaming data transmission path through a relay server.

FIG. 2 is a diagram illustrating the basic flow of the present invention.

FIG. 3A is a flowchart illustrating step S100 in FIG. 2.

FIG. 3B is a flowchart illustrating step S200 in FIG. 2.

FIG. 3C is another flowchart illustrating step S200 in FIG. 2.

FIG. 3D is a flowchart illustrating step S300 in FIG. 2.

FIG. 4 is a timing diagram illustrating step S100 in FIG. 2.

FIG. 5A is a diagram illustrating the concept of DNS query.

FIG. 5B is a timing diagram of connectability test by using a special packet.

FIG. 5C is a timing diagram of changing a transmission path.

FIG. 6 is a schematic diagram of a hardware employing the steaming packet transmission method of the present invention.

FIG. 7 is an interactive flowchart about establishing the streaming data transmission path under the structure as shown in FIG. 6.

FIG. 8 is another interactive flowchart about establishing the streaming data transmission path under the structure as shown in FIG. 6.

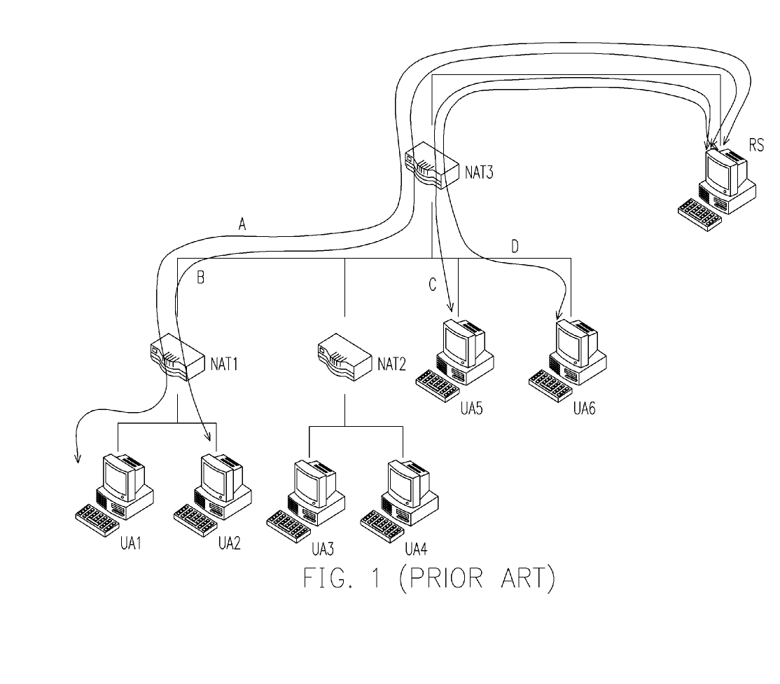

### DESCRIPTION OF EMBODIMENTS

The real-time streaming data transmission method and apparatus according to the embodiments of the present invention will be explained with reference to accompanying drawings.

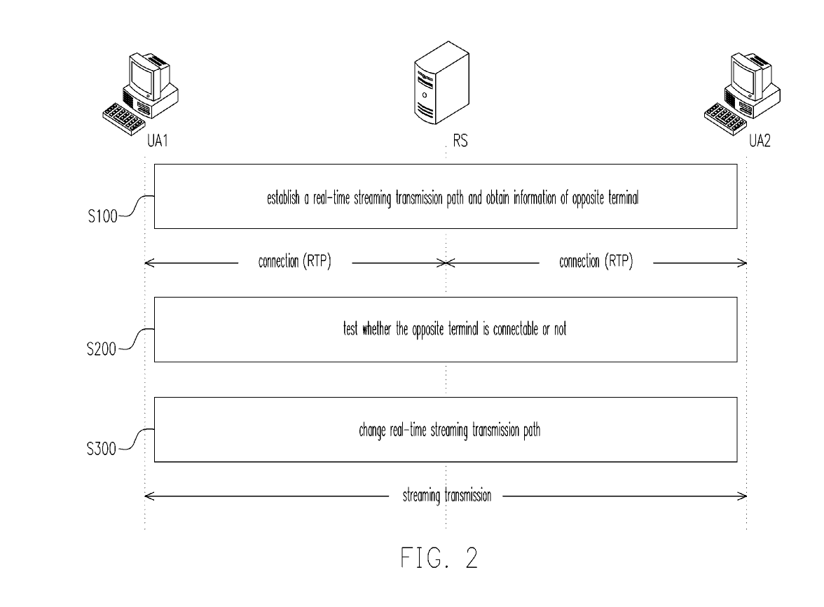

FIG. 2 is a diagram illustrating a basic flow chart according to of the present invention. It is assumed that there is a relay server RS in the VoIP network structure and terminals UA1 and UA2 are going to establish a VoIP real-time streaming data transmission service. In the present embodiment, the terminal UA1 acts as an initial caller and the terminal UA2 as a receiver. Since after the communication is established, both terminals can be the caller or the receiver, the terminals UA1 and UA2 are both referred to as terminals thereinafter to avoid confusion. First, in step S100, a signaling exchange path is established and both terminals obtain information respectively from each other. For example, the terminals UA1 and UA2 establish a real-time media streaming through the relay server RS. This step is similar to the conventional method in that terminal UA1 first obtains the signaling exchange path from the terminal UA2 through the relay server RS, and the terminal UA2 also obtains the signaling exchange path from the terminal UA1 through the relay server RS. However, the difference between step S100 and the conventional technology is that the terminals UA1 and UA2 can obtain information from each other. The detailed steps will be explained below.

Next, in step S200, whether the terminals UA1 and UA2 are connectable with each other is tested. In the foregoing step S100, the terminal UA1 obtains the information of the terminal UA2 (for example, IP address and port number), and at the same time the terminal UA2 also obtains the information of the terminal UA1 (for example, IP address and port number). Therefore, according to the information obtained by both terminals UA1 and UA2, the terminals UA1 and UA2 can test that whether they can connect to each other by using the obtained IP address and the port number. In other words, the terminal UA1 can determines that whether the terminal UA2 is connectable or not from the information of the terminal UA2. Contrarily, the terminal UA2 also can determine that whether the terminal UA1 is connectable or not from the information of the terminal UA1.

Finally, in step S300, the real-time streaming data transmission path is changed. If one or both of the terminals UA1 and UA2 are connectable, i.e., can be directly connected to the other terminals without going through the relay server RS, the real-time streaming data transmission path is changed. For example, if the terminal UA1 can be directly connected to the terminal UA2, then all the real-time streaming data transmission paths from the terminal UA1 to the terminal UA2 are performed in a manner of direct transmission instead of going through the relay server RS. Moreover, if the terminal UA2 can be directly connected to the terminal UA1, then all the real-time streaming data transmission paths from the terminal UA2 to the terminal UA1 are performed in a manner of direct transmission instead of going through the relay server RS. Certainly, if the other terminal is not connectable, then the original transmission path is maintained, i.e., the transmission of the streaming packet is still through the relay server RS. In addition, it is not necessary to notify the relay server RS to change the streaming transmission path if the first or the second terminal does not establish the steaming transmission channel in step S100.

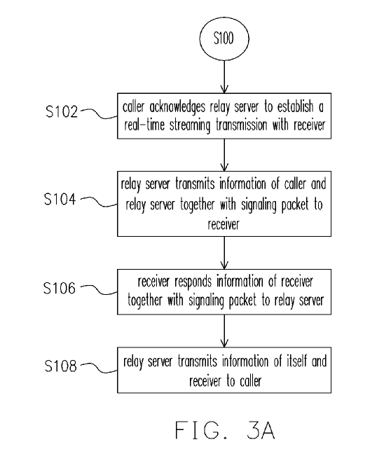

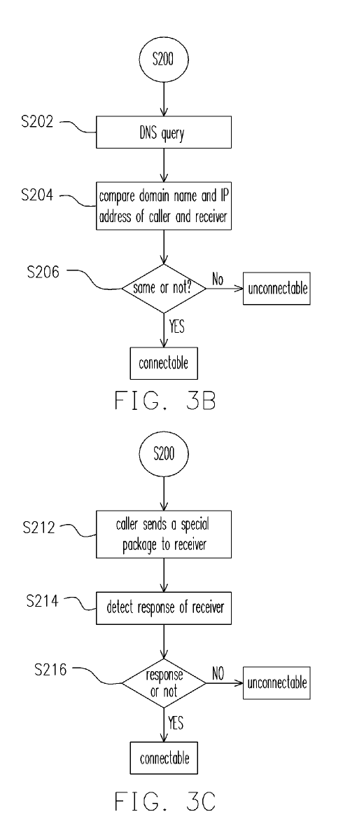

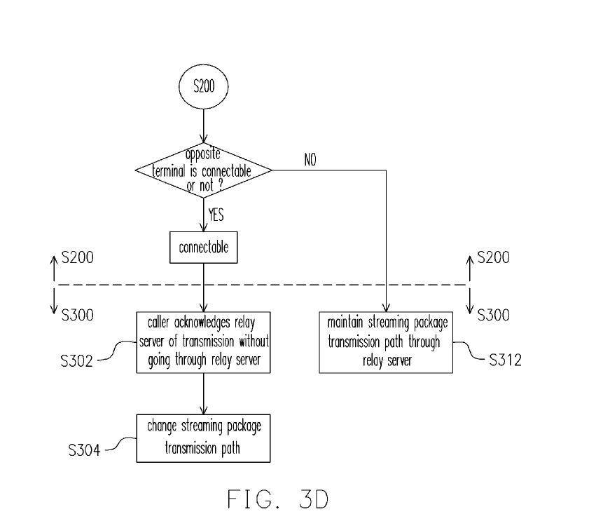

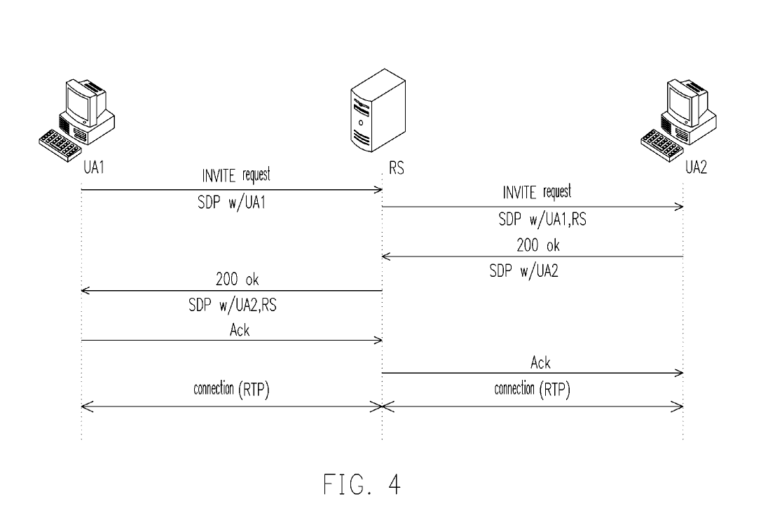

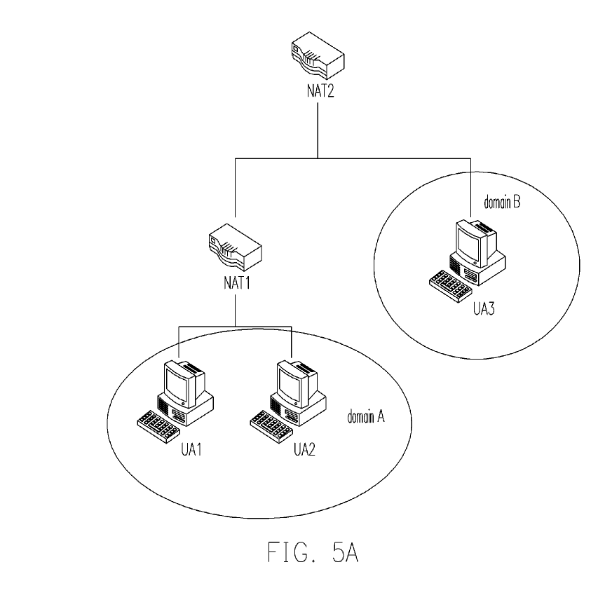

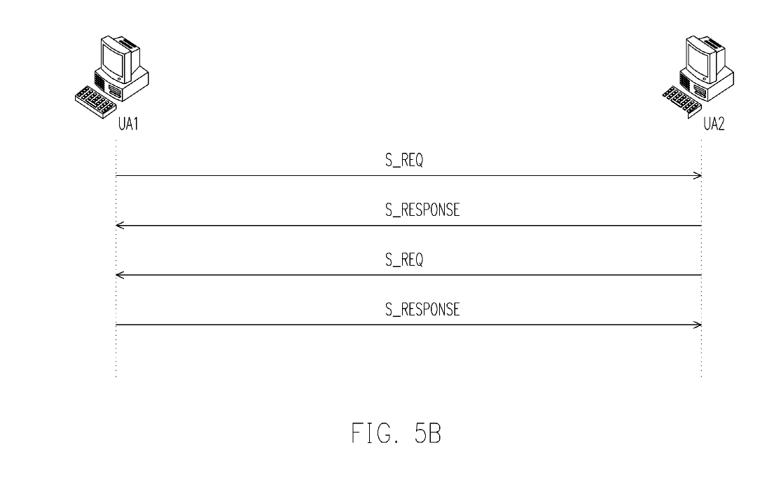

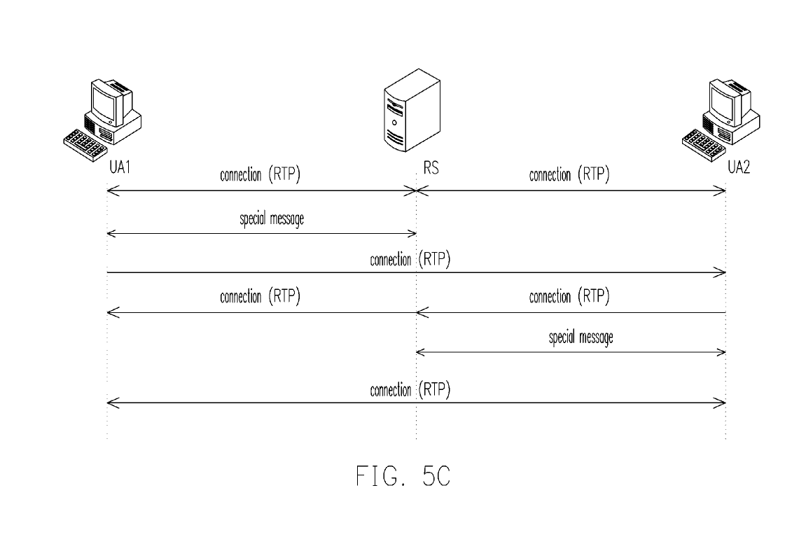

Next, each of steps in FIG. 2 will be explained in detail with reference to FIGS. 3A˜3D, FIG. 4, and FIGS. 5A˜5B. Step S100 in FIG. 2 is described with reference to FIG. 3A and FIG. 4 using SIP VoIP Internet phone real-time streaming server as an example. As shown in FIG. 3A and FIG. 4, in step S102, the caller (terminal) UA1 first acknowledges the relay server RS that a real-time streaming data transmission with the receiver (terminal) UA2 is to be established, and at the same time, the terminal UA1 also sends a signaling packet to the relay server RS. That is, in FIG. 4, the terminal UA1 sends an INVITE REQUEST signal to the relay server RS. The foregoing signaling packet contains session description protocol (SDP). The SDP has no difference from the conventional SDP, and contains information of the terminal UA1 itself, such as IP address, port number etc., i.e., the packet SDP w/UA1 shown in FIG. 4.

Next, in step S104, the relay server RS inserts the information of the relay server RS itself into the foregoing SDP containing the information of the terminal UA1 and sends an INVITE REQUEST signal (i.e. SDP w/UA1, RS) to the terminal UA2. Next, in step S106, when the receiver UA2 receives the INVITE REQUEST signal from the relay server RS, the receiver UA2 response a RESPONSE signal back to the relay server RS, i.e., the 200 OK message as shown in FIG. 4. Meanwhile, the terminal UA2 sends a signaling packet (SDP w/UA2) containing the information of the terminal UA2 back to the relay server RS.

Next, in step S106, the relay server RS inserts the information of the relay server RS itself (i.e., the SDP w/UA2, RS as shown in FIG. 4) into the foregoing SDP containing the information of the terminal UA2 to send it back to the terminal UA1, and transmits a response 200 OK message to the terminal UA1.

In step S108, the terminal UA1 sends an acknowledge message ACK to the relay server RS to establish a real-time transport protocol (RTP) connection between the terminal UA1 and the relay server RS. After that, the relay server RS also transmits an acknowledge message ACK to the terminal UA2 to establish a RTP connection between the terminal UA2 and the relay server RS. The final connection status is as shown in FIG. 4, at first the streaming transmission path between the terminals UA1 and UA2 is through the relay server RS. However, after establishing the connection, the terminals UA1 and UA2 can obtain information, for example, IP address and port number, of each other.

The first terminal UA1 or the second terminal UA2 can establish a streaming transmission channel through the relay server RS after they have obtained the information of the relay server RS and the other terminal.

Next, step S200 in FIG. 2 will be explained with reference to FIGS. 3B˜3C and FIGS. 5A˜5B. As shown in FIG. 3B, in step S200, the terminals UA1 and UA2 test whether the other terminal is connectable or not according to the information of each other obtained in step S100.

In addition, if there is no real-time streaming data transmission path through the relay server RS existing between the first terminal UA1 and the second terminal UA2, the first terminal UA1 can choose to establish a real-time streaming transmission path to the relay server RS first, or also can choose to establish the transmission path after performing the testing process in step S206 or S216 (determining whether it is connectable or not). Similarly, the second terminal UA2 can also choose to establish a real-time streaming transmission path to the relay server RS first, or establish the transmission path after performing the testing process in step S206 or S216.

The object of step S200 as shown in FIG. 2 is that the terminal tests and determines that whether the opposite terminal is connectable or not. Two examples are provided, one uses domain name system (DNS) query, and the other uses a special request for the testing process. First, the DNS query method will be explained. Referring to FIGS. 3B and 5A, terminals UA1 and UA2 are located at domain A and behind the NAT1, and the terminal UA3 is located at domain B and behind the NAT2.

As shown in FIG. 3B, in step S202, assuming that the terminal UA1 performs the DNS query first, and the terminal UA1 acknowledges the terminal UA2 of the domain name and Internet address of the terminal UA1 itself. In step S204, the domain name and the Internet address are compared with each other. In step S206, if the domain name of the terminal UA1 queried by the terminal UA2 is the same as the Internet address of the terminal UA1, i.e., the real-time streaming packet can be transmitted to the other terminal without going through the relay server, and the terminal UA2 is connectable, and vice versa. When the other terminal UA2 is connectable in the example, the streaming packet transmission from the terminal UA1 to the terminal UA2 can be performed directly without going through the relay server RS.

In addition, in the example as shown in FIG. 5A, the terminal outside of the NAT1, for example, the terminal UA3 in domain B, cannot query the terminals UA1 and UA2 behind the NAT1.

Moreover, another method is to perform the testing process using a special request and a special response. In step S100, both terminals UA1 and UA2 know the information such as IP address and port number of one another. Next, referring to FIGS. 3C and 5B, in step S212, the terminal UA1 sends a special request message to the terminal UA2 according to the information of terminal UA2. Next, in step S214, the terminal UA1 detects whether there is a special response message from the terminal UA2. Then in step S216, if the terminal UA1 receives the special response message from the terminal UA2, i.e., the terminal UA1 is connectable to the terminal UA2 without going through the relay server RS. Similarly, FIG. 5B is a timing diagram illustrating the terminal UA2 performing the same step.

Next, step S300 in FIG. 2 is explained with reference to FIGS. 3D and 5C. As shown in FIG. 3B, in step S300, the real-time streaming packet transmission path is changed or unchanged according to the result obtained in step S200.

As shown in FIG. 3D, when the terminal UA2 is determined to be connectable during step S200, the terminal UA1 acknowledges the relay server RS in step S302 that subsequent real-time streaming packet transmission will not go through the relay server RS. Next, in step S304, the terminal UA1 changes the real-time streaming packet transmission path. That is, the subsequent connection is established between the terminals UA1 and UA2, the real-time streaming packets sent by the terminal UA1 are directly transmitted to the terminal UA2 without going through the relay server RS. The timing of the terminal UA1 establishing a direct RTP connection to the terminal UA2 is illustrated in FIG. 5C.

Next, as shown in FIG. 5C, the terminal UA2 can perform similarly. It can be understood that the terminals UA1 and UA2 are connectable each other from the result of the foregoing step S200. Thus, it can be seen clearly in FIG. 5C that the terminal UA2 also acknowledges the relay server RS that the subsequent transmissions will not go through the relay server RS. Next, the terminal UA2 changes the real-time streaming packet transmission path. In other words, the terminal UA2 also transmits real-time streaming packets to the terminal UA1 without going through the relay server RS. Finally, as shown in FIG. 5C, a direct real-time streaming packet transmission path is established between the two terminals UA1 and UA2, so that both terminals can process real-time streaming packet without going through the relay server RS.

In addition, if there is no real-time streaming transmission path existing between the terminal UA1 and the terminal UA2, the first terminal UA1 establishes a direct real-time streaming transmission path to the second terminal UA2 without acknowledging the relay server RS.

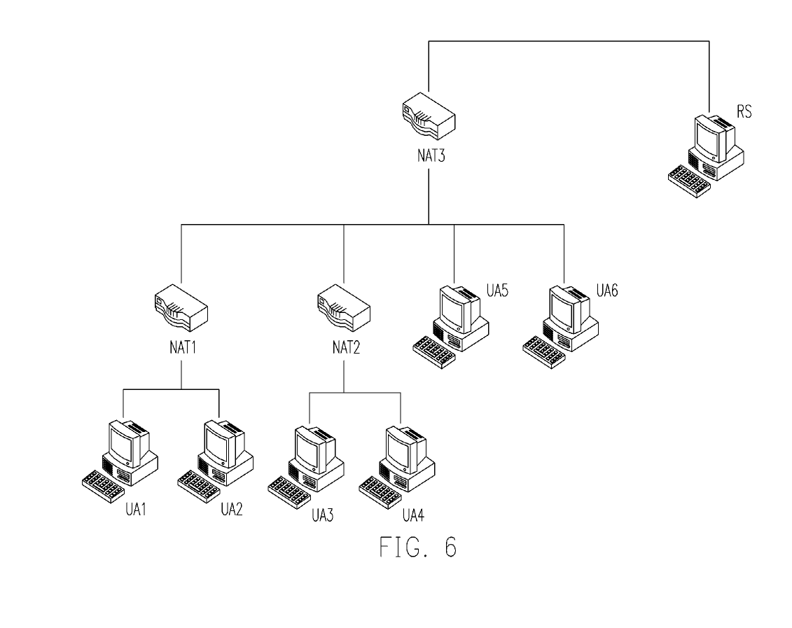

The method for transmitting streaming packet is further explained with examples according to the concept described above. FIG. 6 is a schematic diagram of a hardware employing the steaming packet transmission method of the present invention. As shown in FIG. 6, the structure of the present embodiment includes terminals UA1, UA2 located behind the NAT server NAT1, terminals UA3, UA4 located behind the NAT2, terminals UA5, UA6 located behind the NAT3, and a relay server RS connected to the NAT3. In addition, it is not necessary to set up the terminal equipments behind the NAT; instead, they can use public Internet addresses. In other words, NAT is not a necessary hardware structure.

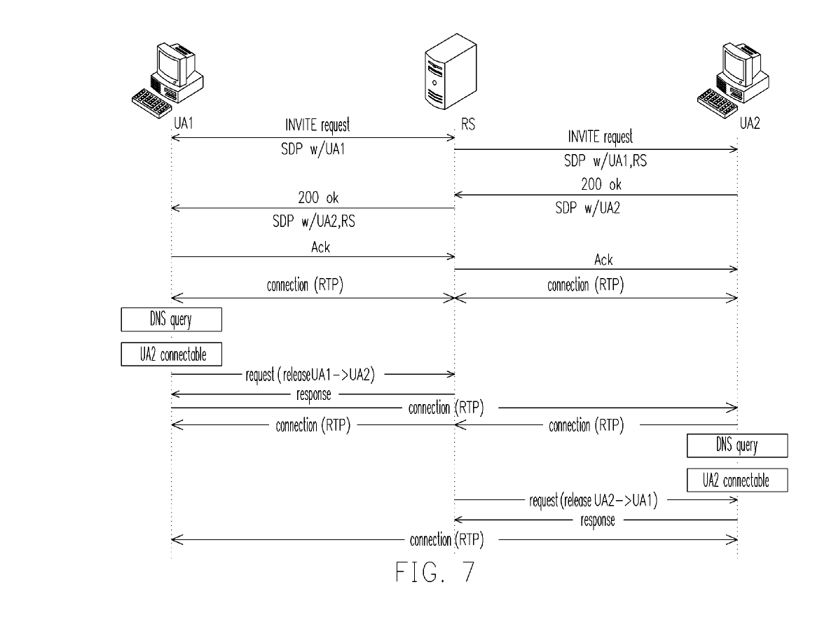

FIG. 7 is an interactive flowchart about establishing the streaming transmission path under the structure as shown in FIG. 6. The streaming packet transmission method between the terminals UA1 and UA2 as shown in FIG. 6 is illustrated in FIG. 7. It can be seen from FIG. 6 that the terminals UA1 and UA2 are located at the same domain and behind the same NAT1.

As shown in FIG. 7, the terminal UA1 first sends a REQUEST signal to the relay server RS through the NAT1 and the NAT2 to establish a streaming packet transmission with the terminal UA2. The REQUEST signal contains SDP and the information of the terminal UA1, for example, IP address and port number, is added thereto. Next, after the relay server receives the SDP (SDP w/UA1) having the information of the terminal UA1, the relay server RS adds the information (IP address and port number) of the relay server RS itself into the SDP and sends a REQUEST signal to the terminal UA2. After the terminal UA2 receives the signal packet (SDP w/UA1, RS), he terminal UA2 sends a 200 OK message to the relay server RS, and inserts information of itself (SDP w/UA2) into the SDP to be sent to the relay server RS. Similarly, after the relay server RS receives the signal packet (SDP w/UA2), the relay server RS inserts its own information to form a signaling packet (SDP w/UA2, RS) and sends a 200 OK message back to the terminal UA1. After the terminal UA1 receives the signaling packet (SDP w/UA2, RS), it sends an acknowledge message ACK back to the relay server RS, and the relay server RS sends the acknowledge message ACK to the terminal UA2. Thus, a streaming packet transmission path (RTP connection) is established between the terminal UA1 and the relay server RS, and a streaming packet transmission path (RTP connection) is also established between the relay server RS and the terminal UA2. Terminals UA1 and UA2 both know the information, i.e., the IP address and the port number, of each other.

Next, the terminal UA1 and the terminal UA2 respectively test whether the opposite terminal is connectable or not. In the present embodiment, the domain name is tested. As shown in FIG. 7, first, the terminal UA1 performs a DNS query according to the received IP address and port number of the terminal UA2 so as to determine whether the terminal UA2 is connectable or not. From FIG. 6, because the terminal UA1 and the terminal UA2 are located at the same domain and behind the same NAT server NAT1, the terminal UA1 knows that the terminal UA2 is connectable after the aforementioned DNS query. Then the terminal UA1 sends a REQUEST signal to the relay server RS and request the relay server RS to release the streaming packet transmission path. Next, the relay server RS responds to the terminal UA1 to acknowledge the terminal UA1 of that the transmission path is released. A direct streaming packet transmission path (RTP connection) is established from the terminal UA1 to the terminal UA2.

Next, the terminal UA2 can perform the same testing steps as described above to test whether the terminal UA1 is connectable or not. Similarly, the terminal UA2 determines that the terminal UA1 is connectable and changes the streaming packet transmission path using the same method as described above. Then streaming packets between the terminals UA1 and UA2 will not go through the relay server RS, instead, the streaming packets are transmitted between the two terminals UA1 and UA2 directly.

Regarding the aforementioned connectability testing between the two terminals UA1 and UA2, the flow as shown in FIG. 7 is initiated by the terminal UA1. However, the flow can also be initiated by the terminal UA2, by both terminals, or by only one of them. The testing method is determined according to the actual requirement.

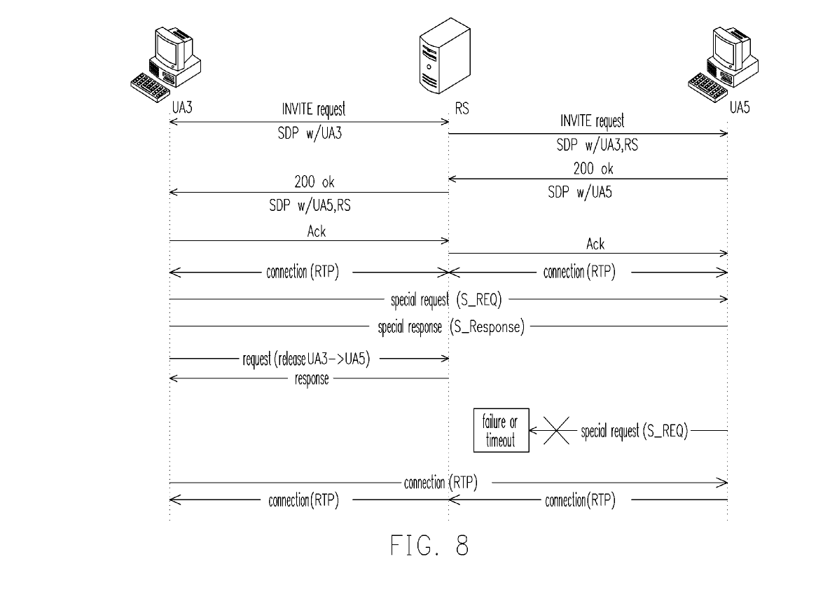

FIG. 8 is another interactive flowchart about establishing the streaming data transmission path under the structure as shown in FIG. 6. The streaming packet transmission method between the terminals UA3 and UA5 as shown in FIG. 6 is illustrated in FIG. 8. It can be seen from FIG. 6 that the terminals UA3 and UA5 are not located at the same domain, and the terminal UA3 is behind the NAT server NAT2 while the terminal UA5 is behind the NAT server NAT3.

The method of establishing streaming packet transmission path between the terminal UA3 and the relay server RS, and between the relay server RS and the terminal UA5 is the same as the method in FIG. 7, and thus no redundant description is made again here. The method in FIG. 8 is to test whether the opposite terminal is connectable by sending a special request.

As shown in FIG. 8, the terminal UA3 sends a special request S-REQ to the terminal UA5 according to the obtained information of the terminal UA5. After the terminal UA5 receives the special request, it sends a special response to the terminal UA3. Here, if the terminal UA3 can receive the special response, then it can get to know that the terminal UA3 can be directly connected to the terminal UA5.

After the terminal UA3 has determined that the terminal UA5 is connectable, the terminal UA3 sends a request to the relay server RS and requests the relay server RS to release the transmission path through the relay server RS. After that, the relay server RS responds the terminal UA3 to acknowledge the terminal UA3 that the path has been released. The terminal UA3 changes the streaming packet transmission path to establish a direct connection (RTP) to the terminal UA5.

Similarly, the terminal UA5 can perform the same steps as described above. Referring to FIG. 8, the terminal UA5 sends a special request message S_REG to the terminal UA3 according to the obtained information of the terminal UA3. Because the terminal UA5 is located outside of the NAT1, the terminal UA5 cannot send the special request S_REQ to the terminal UA3, i.e., the terminal UA3 cannot receive the special request S_REQ sent by the terminal UA5. After the predetermined time has lapsed, a failure connection can be determined; that is, the terminal UA5 cannot establish a direct connection to the terminal UA3. The terminal UA5 will not change the streaming packet transmission path, instead the terminal UA5 keeps the transmission path through the relay server RS.

In summary, according to the present invention, after a real-time streaming transmission path is established through a relay server between two end-users, the two end-users can both obtain the information of the other terminal and the relay server. Thus, the two end-users can test whether the other terminal is directly connectable or not using any method. When the other terminal is directly connectable, the transmission path can be changed so that the transmission does not go through the relay server. When the other terminal is not directly connectable, the transmission path still goes through the relay server.

As described above, in the present invention, the real-time streaming packet transmission path between two end-user terminals can be made as short as possible. Compared with the conventional technology of transmitting data through a relay server, the present invention improves the transmission performance considerably. The improvement is explained according to the following formula:

Tₐ=Σⁿᵢ₌₁t_{NAT}+2*t_{GW}+Σ^{m}ⱼ₌₀t_{NAT}

The above formula is assumed that the caller is connected to the relay server through n NATs, and the receiver is connected to the relay server through m NATs. A possible delay of a real-time streaming packet passing through a NAT is set to t_{NAT}, the delay of the data packet processed by the relay server is set to t_{RS}, and the delay of a single packet transmitted from the caller to the receiver is set to tₜₓ.

When the caller and the receiver are located behind the same NAT, that is, the number of NATs they pass through are the same (n=m), then the delay from the caller to the receiver is expressed below.

Tₜₓ=2*Σⁿᵢ₌₁t_{NAT}+t_{RS}

After the data transmission path is established between the caller and receiver according to the method in the present invention, the data packet will be transmitted by the NAT shared by the caller and the receiver without going through the relay server, thus the delay of the data packet is: tₜₓ=t_{NAT}.

In addition, the relay server has to open two ports (respectively used at the caller and the receiver) for every transmission service. In other words, if there are N transmission services to be performed at the same time, the relay server has to open up 2N transmission ports. However, when the caller and the receiver are located behind the same NAT (the optimal status), the data packet does not need to be relayed by the relay server, so that the burden of the relay server can be reduced considerably.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for transmitting a real-time streaming packet, adapted for a configuration having a first terminal, a second terminal, and a relay server, the method comprising:
(a) establishing a signaling exchange path between the first terminal and the relay server and between the second terminal and the relay server, wherein the first and the second terminal are able to obtain information of each other;
(b) testing whether a direct connection from the first terminal to the second terminal or from the second terminal to the first terminal can be established or not; and
(c) when the first terminal is directly connectable to the second terminal, the first terminal changing a streaming data transmission path to directly connect to the second terminal without going through the relay server, and when the second terminal is directly connectable to the first terminal, the second terminal changing the streaming data transmission path to directly connect to the first terminal without going through the relay server.

2. The real-time streaming packet transmission method as claimed in claim 1 further comprising: after the first and the second terminals obtain information of the relay server and the opposite terminal, the first and the second terminals establishing the streaming data transmission channel through the relay server.

3. The real-time streaming packet transmission method as claimed in claim 1 further comprising: if the streaming data transmission channel is not established in the step (a) by the first or the second terminal, it being not necessary to acknowledge the relay server of changing the streaming data transmission path.

4. The real-time streaming packet transmission method as claimed in claim 1, wherein step (a) further comprising:
the first terminal acknowledging the relay server of that the first terminal is going to establish a real-time streaming data transmission path with the second terminal;
the relay server attaching the information of both the relay server and the first terminal to a signaling packet and transmitting the signaling packet having the information of the first terminal and the relay server to the second terminal;
after the second terminal has received the signaling packet sent by the first terminal, the second terminal responding to the relay server and attaching the information of the second terminal to a signaling packet, and sending the signaling packet to the relay server;
the relay server attaching the information of the second terminal and the relay server to the signaling packet sent by the second terminal, and transmitting the signaling packet having the information of the relay server and the second terminal to the first terminal; and
if there is no real-time streaming data transmission path existing between the first and the second terminal yet, the first terminal choosing to establish a real-time streaming data transmission path with the relay server first or choosing to establish the real-time streaming data transmission path after performing testing in the step (b), or the second terminal choosing to establish a real-time streaming data transmission path with the relay server or choosing to establish the transmission path after performing the testing in the step (b).

5. The real-time streaming packet transmission method as claimed in claim 1, wherein the step (b) further comprising:
the first terminal acknowledging the second terminal of domain information of the first terminal;
the second terminal querying domain information of the first terminal; and
when the domain information acknowledged by the first terminal is consistent with the domain information queried by the second terminal, the first terminal determining that the second terminal is directly connectable.

6. The real-time streaming packet transmission method as claimed in claim 1, wherein the step (b) further comprising:
the first terminal sending a special packet to the second terminal according to the information of the second terminal obtained in the step (a);
if the second terminal receives the special packet and responds to the first terminal, the first terminal determining that the second terminal is directly connectable.

7. The real-time streaming packet transmission method as claimed in claim 1, wherein the step (c) further comprising:
when the first terminal determining that the second terminal is directly connectable and a real-time streaming data transmission path through the relay server existing between the first and the second terminal, the first terminal sending an acknowledge signal to the relay server and requesting the relay server to release the real-time streaming packet transmission path;
after the first terminal has received the response of the relay server, the first terminal changing the real-time streaming packet transmission path to directly transmit the real-time streaming packet to the second terminal without going through the second terminal; if there is no real-time streaming transmission path existing between the first and the second terminal yet, the first terminal directly establishing the streaming data transmission path with the second terminal without acknowledging the relay server.

8. The real-time streaming packet transmission method as claimed in claim 7, wherein when the first terminal determines that the second terminal is not able to be connected directly, the first terminal maintains the real-time streaming packet transmission path to the second terminal through the relay server.

9. The real-time streaming packet transmission method as claimed in claim 1, wherein the information of the first terminal, the second terminal, and the relay server includes Internet addresses and port numbers.

10. A real-time streaming packet transmission apparatus, comprising:
a relay server configured on the Internet, for relaying a real-time streaming packet;
a first terminal connected to the relay server through the Internet, wherein when the first terminal sends a request signal to the relay server to establish a real-time streaming transmission path, information of the first terminal is attached to a signaling packet to be sent to the relay server; and
a second terminal connected to the relay server through the Internet, wherein the relay server attaches information of the relay server to the signaling packet having the information of the first terminal and sends the signal packet having the information of the first terminal and the relay server to the second terminal, and the second terminal transmits its own information back to the first terminal through the relay server;
wherein the first and the second terminal respectively test whether the second and the first terminal are directly connectable or not according to the received information of the second and the first terminal, when the first terminal is directly connectable to the second terminal, the first terminal changes the streaming transmission path to directly connect to the second terminal without going through the relay server, and when the second terminal is directly connectable to the first terminal, the second terminal changes the streaming data transmission path to directly connect to the first terminal without going through the relay server.

11. The real-time streaming packet transmission apparatus as claimed in claim 10, wherein a DNS query is used for testing whether the second terminal is able to be directly connected to the first terminal or not, and wherein the first terminal acknowledges the second terminal of domain information of the first terminal, the second terminal queries for the domain information of the first terminal, and when the domain information acknowledged by the first terminal and the domain information queried by the second terminal are identical, the first terminal determines that the second terminal is directly connectable.

12. The real-time streaming packet transmission apparatus as claimed in claim 10, wherein a special request is used for testing whether the second terminal is able to be directly connected to the first terminal, and wherein the first terminal sends a special packet to the second terminal according to the obtained information of the second terminal, if the second terminal receives the special packet and responds to the first terminal, the first terminal determines that the second terminal is directly connectable.

13. The real-time streaming packet transmission apparatus as claimed in claim 10, wherein when the first terminal determines that the second terminal is directly connectable, the first terminal sends an acknowledge signal to the relay server and requests the relay server to release the real-time streaming transmission path, and after the first terminal has received the response of the relay server, the first terminal changes the real-time streaming transmission path to directly transmit the real-time streaming packet to the second terminal without going through the relay server.

14. The real-time streaming packet transmission apparatus as claimed in claim 13, wherein when the first terminal determines that the second terminal is not able to be connected directly, the first terminal maintains the real-time streaming transmission path to the second terminal through the relay server.

15. The real-time streaming packet transmission apparatus as claimed in claim 10, wherein when there is no real-time streaming transmission path through the relay server existing between the first and the second terminal, and the second terminal is determined being not directly connectable, the first terminal has to establish the real-time streaming transmission path with the relay server for transmitting real-time streaming data.

16. The real-time streaming packet transmission apparatus as claimed in claim 10, wherein the information of the first terminal, the second terminal, and the relay server includes Internet addresses and port numbers.
